(19) United States
(12) Patent Application Publication
(10) Pub. No.: US 2021/0156712 A1
(43) Pub. Date: May 27, 2021

(54) MOBILE DEVICE, SERVER AND METHOD FOR UPDATING AND PROVIDING A HIGHLY PRECISE MAP

(71) Applicant: Robert Bosch GmbH, Stuttgart (DE)

(72) Inventor: Marlon Ramon Ewert, Untergruppenbach (DE)

(21) Appl. No.: 16/641,472

(22) PCT Filed: Aug. 16, 2018
(86) PCT No.: PCT/EP2018/072250

§ 371 Date: Feb. 24, 2020

(30) Foreign Application Priority Data
Aug. 25, 2017 (DE) 10 2017 214 921.3

(51) Int. Cl. G01C 21/00; G01C 21/36; G01C 21/32; G05D 1/02

(52) U.S. Cl. CPC G01C 21/3848; G01C 21/3602; G05D 1/0285; G01C 21/3885; G01C 21/32

(57) ABSTRACT

A mobile device for updating and transmitting a highly precise map, a server for receiving and transmitting a highly precise map, and a method for transmitting and providing a first and/or a highly precise map, are described.

The present invention relates to a mobile device for updating and transmitting a highly precise map, including a first transceiver unit, a localization sensor system, a surroundings sensor system, a display unit and an input unit, and a server for receiving and transmitting a highly precise map, including a second transceiver unit and an interface. The present invention furthermore relates to a method for transmitting and providing a first and/or a highly precise map, including transmitting the first map from the external server to the mobile device, transmitting the highly precise map from the mobile device to the external server, and providing the first map and/or the highly precise map for the operation of an automated vehicle.

### SUMMARY

An example mobile device according to the present invention for updating and transmitting a highly precise map includes a first transceiver unit for receiving first map data and transmitting second map data, the first map data representing a first map, the first map data being received from an external server, the second map data representing the highly precise map, and the second map data being transmitted to the external server. The mobile device furthermore includes a localization sensor system, which is designed to determine a highly precise position of the mobile device, a surroundings sensor system for detecting surroundings data values, the surroundings data values representing surroundings of the mobile device, a display unit for displaying the first map and/or highly precise map, and an input unit for detecting an input signal, the input signal causing at least one change of the first map and/or of the highly precise map, as a function of the highly precise position and/or the surroundings.

A first map and/or a highly precise map shall be understood to mean a digital map which is present in the form of (map) data values on a storage medium. For example, the first and/or highly precise map is designed in such a way that one or multiple map layers is/are encompassed, a map layer showing a map from a bird's eye view (course and position of roads, buildings, landscape features, etc.), for example. This corresponds to a map of a navigation system, for example. Another map layer encompasses a radar map, for example, the surroundings features encompassed by the radar map being stored together with a radar signature. Another map layer encompasses a LIDAR map, for example, the surroundings features encompassed by the LIDAR map being stored together with a LIDAR signature.

The first and/or the highly precise map is/are, in particular, designed in such a way that they are suitable for navigating a vehicle, in particular, an automated vehicle. For this purpose, the individual map layers encompass, for example, surroundings features having a GPS position, this position being known in a highly precise manner. The surroundings features represent the surroundings (of the mobile device and/or of the automated vehicle), for example in the form of buildings and/or landscape features (lakes, rivers, mountains, forests, etc.) and/or traffic infrastructure features and/or further features.

In one specific embodiment, the highly precise map represents the updated first map. In a further specific embodiment, the highly precise map is newly created, proceeding from the first map.

A highly precise position shall be understood to be a position which is so precise within a predefined coordinate system, for example GNSS coordinates, that this position does not exceed a maximum permissible lack of definition. The maximum lack of definition may, for example, depend on the surroundings—for example the number and/or definition of the surroundings features. Furthermore, the maximum lack of definition may, for example, depend on whether the automated vehicle is operated in a semi, highly or fully automated manner. In principle, the maximum lack of definition is so low that, in particular, a safe operation of the automated vehicle is ensured. For a fully automated operation of the automated vehicle, the maximum lack of definition is in an order of magnitude of approximately 10 centimeters, for example.

Different applications exist, in particular, the operation—navigation, localization, movement with the aid of transverse and/or longitudinal control, etc.—of an automated vehicle, which are dependent on a highly precise map. The mobile device according to the present invention advantageously contributes to this by easily, quickly, and up-to-the-minute transmitting surroundings detected in a highly precise manner to a server in the form of a highly precise map. In particular, short notice changes—for example, of courses of roads due to construction sites, accidents, natural disasters, events, etc.—are detected, transmitted to the server and provided for automated vehicles, for example proceeding from the server.

The localization sensor system preferably includes a GNSS unit, the GNSS unit being at least designed to receive correction data in such a way that the mobile device is localized in a highly precise manner.

A GNSS unit shall be understood to mean, for example, a system for position determination and navigation on the earth and in the air by receiving signals from navigation satellites and pseudolites, the correction data being provided, for example, by a service station specifically designed therefor.

A highly precise localization shall be understood to mean the determination of a highly precise position.

This yields the advantage that the mobile device is usable worldwide, and the highly precise map which is updated with the aid of the mobile device may be reliably used worldwide.

The input unit is preferably designed to detect the input signal with the aid of pressure onto the input unit.

The input unit corresponds to a touch screen, for example. Within the scope of the present invention, as an alternative or in addition, further specific embodiments of the input unit are possible, such as a keyboard and/or a microphone for an audio input.

This yields the advantage that the mobile device may be operated quickly and comfortably.

The surroundings sensor system is preferably designed to detect the surroundings of the mobile device in such a way that the length ratio and/or the proportions of at least one object in the surroundings are detected, the length ratio and/or the proportions of the at least one object being used to change the first and/or highly precise map.

The surroundings sensor system shall be understood to mean at least one video and/or radar and/or LIDAR and/or ultrasonic and/or at least one further sensor which is/are designed to detect the surroundings in this way.

The objects correspond to the surroundings features, for example, which are encompassed by the first and/or the highly precise map.

This yields the advantage that, in particular, the instantaneous state of the surroundings is detected with the aid of the surroundings sensor system, for example objects in the surroundings which are not encompassed by the first map being linked to a highly precise position (or their highly precise position being determined) and subsequently integrated into the first map, which is subsequently present as a highly precise map.

The at least one object is preferably designed as a traffic route, the surroundings sensor system being designed to detect a number of traffic lanes of the traffic route and/or a width of the respective traffic lane and/or a course of the respective traffic lane as the length ratio and/or the proportions. The instantaneous state of a traffic route which is advantageously detected with the aid of the mobile device is, in particular, highly relevant for a safe and reliable operation of an automated vehicle. In particular, construction sites temporarily or permanently result in major changes (in the case of construction sites, for example, the left traffic lane of a multi-lane traffic route of each driving direction may be relocated to the opposite traffic lane, etc.).

The mobile device is preferably designed to be movable.

This shall be understood to mean that the mobile device is configured in such a way, for example, that it may be moved by one person—without being carried—(for example with the aid of wheels).

This yields the advantage that the mobile device may be moved comfortably.

The highly precise map preferably includes a time stamp which represents the validity of the highly precise map.

A time stamp shall be understood to mean a date, for example, on which the highly precise map is created. In addition or as an alternative, for example, the time stamp furthermore includes a validity, for example a duration in hours and/or days and/or weeks, etc., and/or a further date and/or a time, which represents an expiration of the validity.

This yields the advantage that the highly precise map, in particular in the case of an only temporary change in the surroundings, is, for example, replaced again with the first map (on the server), without the surroundings having to be detected again. This shall be understood to mean, for example, that the first map is provided again, instead of the highly precise map, as a function of the time stamp.

The example server according to the present invention for receiving and transmitting a highly precise map includes a second transceiver unit for transmitting first map data and for receiving second map data, the first map data representing a first map, the first map data being transmitted to a mobile device designed according to at least one of the present specific embodiments, the second map data representing the highly precise map, the second map data being received from the mobile device. The server according to the present invention furthermore includes an interface for providing the first map and/or the highly precise map in such a way that the first map and/or the highly precise map may be retrieved by at least one automated vehicle, for operating the automated vehicle.

This yields the advantage that the operation—navigation, localization, movement with the aid of transverse and/or longitudinal control, etc.—of an automated vehicle takes place safely and reliably as a function of the highly precise map in that this map is provided and may be retrieved at any time.

A memory unit is preferably encompassed, which stores the first map and/or the highly precise map.

A memory unit shall be understood to mean a unit which is able to store digital data.

This yields the advantage that, for example, the highly precise map may be replaced with the first map again at any time.

The highly precise map preferably includes a time stamp which represents the validity duration of the highly precise map. The interface is designed in such a way that the first map or the highly precise map is provided as a function of the validity duration.

This yields the advantage that always the most up-to-date and/or most precise map is provided.

The method according to the present invention for transmitting and providing a first and/or a highly precise map includes a step of transmitting the first map from an external server, which is designed according to at least one of the present specific embodiments, to a mobile device, which is designed according to at least one of the present specific embodiments, a step of transmitting the highly precise map from the mobile device to the external server, and a step of providing the first map and/or the highly precise map in such a way that the first map and/or the highly precise map may be retrieved by at least one automated vehicle, for operating the automated vehicle.

The highly precise map preferably includes a time stamp which represents the validity duration of the highly precise map, the first map or the highly precise map being provided as a function of the validity duration. Advantageous refinements of the present invention are described herein.

All specific embodiments and/or descriptions and/or definitions and/or advantages apply to all features and/or corresponding specific embodiments of the present inventions which are equivalently used and/or mentioned, unless it is expressly pointed out that this is not the case.

### BRIEF DESCRIPTION OF THE DRAWINGS

Exemplary embodiments of the present invention are shown in the figures and are described in greater detail below.

FIG. 1 shows one exemplary embodiment of a mobile device according to the present invention purely by way of example.

FIG. 2 shows one exemplary embodiment of a server according to the present invention purely by way of example.

FIG. 3 shows one exemplary embodiment of the method according to the present invention in the form of a flow chart purely by way of example.

### DETAILED DESCRIPTION OF EXAMPLE EMBODIMENTS

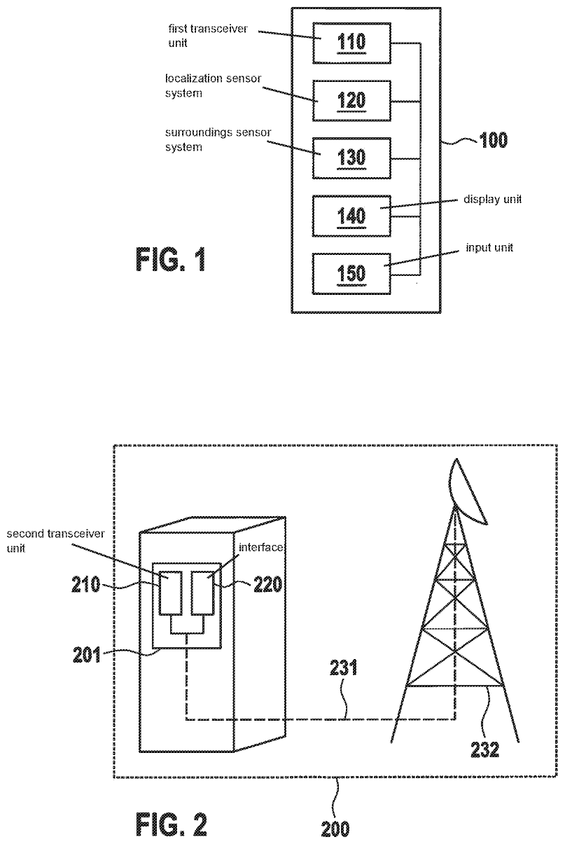

Purely by way of example, FIG. 1 shows an example mobile device 100 for updating and transmitting a highly precise map, which includes a first transceiver unit 110 for receiving first map data and transmitting second map data, the first map data representing a first map, the first map data being received from an external server 200, the second map data representing the highly precise map, and the second map data being transmitted to external server 200, and a localization sensor system 120, which is designed to determine a highly precise position of the mobile device. Mobile device 100 furthermore includes a surroundings sensor system 130 for detecting surroundings data values, the surroundings data values representing surroundings of mobile device 100, a display unit 140 for displaying the first map and/or highly precise map, and an input unit 150 for detecting an input signal, the input signal causing at least one change of the first map and/or of the highly precise map, as a function of the highly precise position and/or the surroundings.

In one specific embodiment, first transceiver unit 110 is designed, for example, in such a way that it is connected to an externally situated transceiver unit—proceeding from mobile device 100—with the aid of a cable link and/or wireless link. Furthermore, first transceiver unit 110 includes electronic data processing elements, for example a processor, a working memory and a hard drive, which are designed to store and/or to process the first and/or second map data, for example to carry out a change and/or an adaptation of the data format.

In one specific embodiment, display unit 140 is designed as a screen, for example.

Purely by way of example, FIG. 2 shows an example server 200 for receiving and transmitting a highly precise map, which includes a second transceiver unit 210 for transmitting first map data and for receiving second map data, the first map data representing a first map, the first map data being transmitted to a mobile device 100, which is designed according to at least one of the specific embodiments described here or a combination of the specific embodiments described here, the second map data representing the highly precise map, the second map data being received from the mobile device 100. Server 200 furthermore includes an interface 220 for providing the first map and/or the highly precise map in such a way that the first map and/or the highly precise map may be retrieved by at least one automated vehicle, for operating the automated vehicle.

Server 200 includes a processing unit 201. In one further specific embodiment, server 200 or processing unit 201 shall be understood to mean a cloud—i.e., a combination of at least two electric data processing systems—which exchange data via the Internet, for example. In one further specific embodiment, processing unit 201 corresponds to server 200.

Second transceiver unit 210 and/or interface 220 may—as a function of the particular specific embodiment of server 200 and/or of processing unit 201—have differing designs. In one specific embodiment, server 200 and/or processing unit 201 is/are localized in the same location—as one unit.

In one further specific embodiment, server 200 and/or processing unit 201 is/are designed as a cloud, second transceiver unit 210 and/or interface 220 being localized in differing locations, for example in differing cities and/or in differing countries, server 200 and/or processing unit 201 being designed, for example, to exchange data with the aid of a suitable data link—such as the Internet.

Second transceiver unit 210 is designed to transmit first map data and to receive second map data. In one further specific embodiment, second transceiver unit 210 is designed in such a way that it is connected to an externally situated transceiver unit 232—proceeding from server 200—with the aid of a cable link and/or wireless link 231. Furthermore, second transceiver unit 210 includes electronic data processing elements, for example a processor, a working memory and a hard drive, which are designed to store and/or to process the first and/or second map data, for example to carry out a change and/or an adaptation of the data format, and to subsequently forward them to interface 220.

Server 200 and/or processing unit 201 furthermore include an interface 220 for providing the first map and/or the highly precise map. For this purpose, interface 220 also includes a transceiver unit, for example, with the aid of which data are requested and/or transmitted. In one further specific embodiment, interface 220 is designed in such a way that it is connected to an externally situated transceiver unit 232—proceeding from server 200—with the aid of a cable link and/or wireless link 231. In one further specific embodiment, second transceiver unit 210 and interface 220 are identical.

Interface 220 furthermore includes electronic data processing elements, for example a processor, a working memory and a hard drive, which are designed to process the first map and/or the highly precise map in the form of data values, for example to carry out a change and/or an adaptation of the data format, and to subsequently provide them.

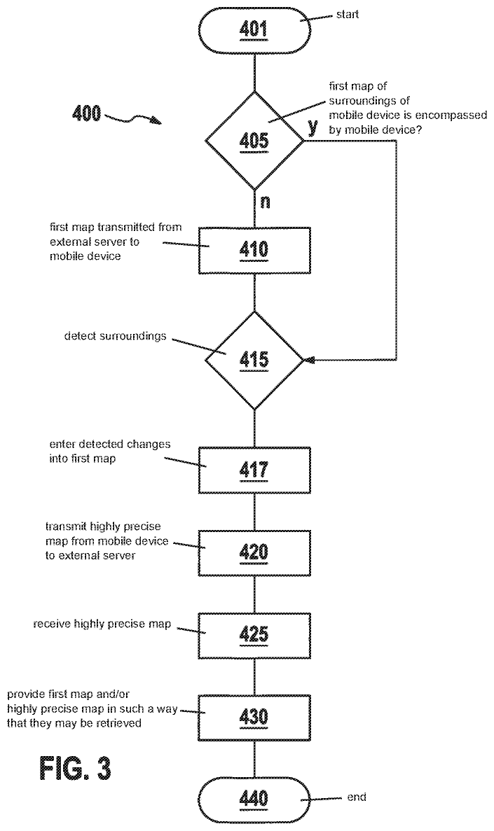

FIG. 3 shows one exemplary embodiment of a method 400 according to the present invention in the form of a flow chart, purely by way of example.

In step 401, the method starts. This takes place, for example, by carrying out a change of an object, in particular, of a traffic route—for example by a corresponding construction firm—and subsequently mobile device 100—for example by an employee of the construction firm—is used to detect the object.

In step 405, it is checked, for example, whether a first map of the surroundings of mobile device 100 is encompassed by mobile device 100. If not, first map data, the first map data representing a first map, are requested, for example, with the aid of first transceiver unit 110 from an external server 200 by transmitting a corresponding signal to external server 200. Thereafter, step 410 follows. If the first map is encompassed by mobile device 100, step 415 follows.

In step 410, the first map is transmitted from external server 200 to mobile device 100. For this purpose, server 200, for example, includes a second transceiver unit 210 for transmitting the first map data. Thereafter, step 415 follows.

In step 415, mobile device 100 is moved along the change in such a way that the surroundings are detected with the aid of a localization sensor system 120, which is designed to determine a highly precise position of mobile device 100, and with the aid of a surroundings sensor system 130 for detecting surroundings data values, the surroundings data values representing the surroundings of mobile device 100, and that surroundings features encompassed by the surroundings are linked—proceeding from mobile device 100—to highly precise positions. This takes place, for example, in that the highly precise position of mobile device 100 is determined at regular intervals (for example every second) and the surroundings features are detected in such a way that a distance and/or an orientation of the surroundings features with respect to mobile device 100 is/are determined. Subsequently, the respective highly precise position of the surroundings features may be derived with the aid of a vector addition. The distances and/or the orientation may be determined, for example, in that surroundings sensor system 130 includes a stereo camera and a corresponding evaluation unit.

In step 417, the detected changes, which are each linked to a highly precise position, are entered into the first map, which is subsequently present as a highly precise map. In an alternative specific embodiment, the highly precise map is newly created, based on the first map data and the detected surroundings data values. The creation of the highly precise map takes place, for example, in that the first map and/or the highly precise map is/are displayed with the aid of a display unit 140, and the change is carried out and/or entered and/or checked and/or corrected—for example by an employee of the construction firm—with the aid of an input unit 150 for detecting an input signal.

In step 420, the highly precise map is transmitted from mobile device 100, with the aid of first transceiver unit 110, to external server 200.

In step 425, the highly precise map is received from external server 200, with the aid of second transceiver unit 210.

In step 430, the first map and/or the highly precise map is/are provided in such a way with the aid of an interface 220 that the first map and/or the highly precise map may be retrieved by at least one automated vehicle, for operating the automated vehicle.

In step 440, method 400 ends.

1-12. (canceled)

13. A mobile device for updating and transmitting a highly precise map, comprising:
a first transceiver unit configured to receive first map data and to transmit second map data, the first map data representing a first map, the first map data being received from an external server, the second map data representing the highly precise map, the second map data being transmitted to the external server;
a localization sensor system configured to determine a highly precise position of the mobile device;
a surroundings sensor system configured to detect surroundings data values, the surroundings data values representing surroundings of the mobile device;
a display unit configured to display the first map and/or highly precise map;
an input unit configured to detect an input signal, the input signal causing at least one change of the first map and/or of the highly precise map, as a function of the highly precise position and/or the surroundings.

14. The mobile device as recited in claim 13, wherein the localization sensor system includes a GNSS unit, the GNSS unit being configured to receive correction data in such a way that the mobile device is localized in a highly precise manner.

15. The mobile device as recited in claim 13, wherein the input unit is configured to detect the input signal with the aid of pressure onto the input unit.

16. The mobile device as recited in claim 13, wherein the surroundings sensor system is configured to detect the surroundings of the mobile device in such a way that a length ratio and/or proportions of at least one object in the surroundings are detected, the length ratio and/or the proportions of the at least one object being used to change the first and/or highly precise map.

17. The mobile device as recited in claim 16, wherein the at least one object is designed as a traffic route, the surroundings sensor system being configured to detect a number of traffic lanes of a traffic route and/or a width of a respective traffic lane and/or a course of the respective traffic lane as the length ratio and/or the proportions.

18. The mobile device as recited in claim 16, wherein the mobile device is movable.

19. The mobile device as recited in claim 16, wherein the highly precise map includes a time stamp which represents validity of the highly precise map.

20. A server configured to receive and transmit a highly precise map, the server comprising:
a second transceiver unit configured to transmit first map data and to receive second map data, the first map data representing a first map, the first map data being transmitted to a mobile device, the second map data representing the highly precise map, the second map data being received from the mobile device; and
an interface configured to provide the first map and/or the highly precise map in such a way that the first map and/or the highly precise map may be retrieved by at least one automated vehicle for operating the automated vehicle.

21. The server as recited in claim 20, further comprising:
a memory unit which stores the first map and/or the highly precise map.

22. The server as recited in claim 20, wherein the highly precise map includes a time stamp which represents validity duration of the highly precise map, and the interface is configured in such a way that the first map or the highly precise map is provided as a function of the validity duration.

23. A method for transmitting and providing a first and/or a highly precise map, the method comprising the following steps:
transmitting the first map from an external server to a mobile device, the external server including a second transceiver unit configured to transmit the first map data and to receive second map data, the first map data representing the first map, the first map data being transmitted to the mobile device, the second map data representing the highly precise map, the second map data being received from the mobile device, and an interface configured to provide the first map and/or the highly precise map in such a way that the first map and/or the highly precise map may be retrieved by at least one automated vehicle for operating the automated vehicle, the mobile device including a first transceiver unit configured to receive the first map data from the external server and to transmit the second map data to the external server, a localization sensor system configured to determine a highly precise position of the mobile device, a surroundings sensor system configured to detect surroundings data values, the surroundings data values representing surroundings of the mobile device, a display unit configured to display the first map and/or highly precise map, and an input unit configured to detect an input signal, the input signal causing at least one change of the first map and/or of the highly precise map, as a function of the highly precise position and/or the surroundings;
transmitting the highly precise map from the mobile device to the external server; and
providing the first map and/or the highly precise map in such a way that the first map and/or the highly precise map may be retrieved by at least one automated vehicle for operating the automated vehicle.

24. The method as recited in claim 23, wherein the highly precise map includes a time stamp which represents a validity duration of the highly precise map, the first map or the highly precise map being provided as a function of the validity duration.
